(19) United States
(12) Patent Application Publication
(10) Pub. No.: US 2010/0133971 A1
(43) Pub. Date: Jun. 3, 2010

(54) ILLUMINATING DEVICE

(75) Inventors: Juergen Flechsig, Plauen (DE); Carsten Marcel Riedel, Plauen (DE); Lutz Kaeseberg, Plauen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/521,634

(22) PCT Filed: Jan. 4, 2008
(86) PCT No.: PCT/IB2008/050012

§ 371 Date: Jun. 29, 2009

(30) Foreign Application Priority Data
Jan. 9, 2007 (EP) 07100279.4

(51) Int. Cl. H01K 1/58

(52) U.S. Cl. 313/43

(57) ABSTRACT

An illuminating device is disclosed which comprises a light source (5) for generating light and an after-glowing material (for example a luminescent pigment), especially for emitting light after the light source is switched off or has extinguished. The after-glowing material is applied onto a carrier (1), which has a predetermined thermal isolation from the light source (5). By this, the duration of the after-glowing can be extended.

### FIELD OF THE INVENTION

The invention relates to an illuminating device comprising a light source for generating light and an after-glowing material which is provided for emitting light after the light source is switched off or has extinguished.

### BACKGROUND OF THE INVENTION

Illuminating devices comprising an after-glowing material are known. They are applied, inter alia, in so called luminous signs for advertising purposes, e.g. in shops, hotels, airports, etc. or for other purposes. They can also be used in guiding boards as “exit”-signs, in billboards, traffic lights, systems for guiding traffic flows and as (e.g. dashboard) lighting in vehicles. They can also be applied in automotive lamps. Such and other illuminating devices are used both as interior lighting and exterior lighting.

An illuminating device which comprises a light means and a light emitter with an after-glowing material for emitting light after the light means is switched off or has extinguished is known from WO 2004/034358. The light emitter comprises a predetermined pattern for displaying information, and is provided on an electric lamp, on the light emission window of a luminaire or on the display window of a display device.

However, a problem or disadvantage of the above illuminating devices is the fact, that the duration of the after-glowing effect after switching off or extinguishing the light means is limited and for some applications even too short.

### SUMMARY OF THE INVENTION

An object underlying the invention is to provide an illuminating device comprising a light source and an after-glowing material as mentioned above which has a prolonged duration of after-glowing after the light source is switched off or has extinguished.

According to claim 1 an illuminating device is provided which comprises a light source for generating light and an after-glowing material for emitting light after the light source is switched off or has extinguished, wherein a carrier is provided onto which the after-glowing material is applied and which carrier is formed to surround at least a part of the light source in a longitudinal and/or circumferential direction of the light source, and wherein at least one thermal isolation layer is provided between the light source and the carrier in order to decrease a heating of the carrier by the light source.

The invention is based on the insight of the inventors that the duration of after-glowing effect of the after-glowing material can be extended or prolonged if the temperature of the after-glowing material is decreased. This is achieved by providing said carrier and said thermal isolation layer.

The light source is for example at least one filament lamp, halogen lamp, discharge lamp or light emitting diode, also in combination with each other. The after-glowing material is for example a luminescent or phosphorescent material or a related pigment layer.

Advantageously, the illuminating device is provided in the form of a vehicle head lamp (or back light) unit, comprising a light source in the form of a halogen socket lamp (or a halogen lamp), wherein even in such (and other) applications, in which high temperatures occur due to a substantially closed outer housing which surrounds the lamp, a considerable prolonged after-glowing effect can be achieved due to the decreased temperature of the after-glowing material.

The subclaims disclose advantageous embodiments of the invention. The embodiment according to claim 2 has the advantage that the carrier and the light source can be assembled very quick and easy especially if the light source is operated in an upright position or orientation, so that the carrier stands on the socket. Furthermore, by at least partly surrounding the lamp bulb with the carrier, the after-glowing material which is applied onto the carrier is effectively radiated by the light generated by the light source during its operation (especially if the lamp is inserted into a related reflector), so that the duration of the after glowing effect after switching off the light source is additionally prolonged.

The thermal isolation layer according to claim 3 has the advantage that it is especially effective for thermally isolating the carrier, whereas the thermal isolation layer according to claim 4 can be used as well to fix the carrier at the light source.

Generally, the thickness of the isolation layer is selected as large as possible in order to increase the thermal isolation as far as possible. However, in case that the light source and the carrier is built into a lighting unit, for example a head light unit of a vehicle, the maximum thickness of the isolation layer is given by the inner extensions or space of this lighting unit. Consequently, a minimum thickness of a few millimeters is generally preferred as a matter of compromise, for which on the one hand an effective thermal isolation is achieved and on the other hand the space which is required for such a thickness is available within common lighting units.

In case of surroundings with high temperatures, a carrier made of a metal material is usually preferred according to claim 5, however an accordingly temperature resistant synthetic material, especially a translucent material can be used as well, which latter has the advantage, that the after-glowing material applied onto the carrier is radiated by the light of the light source more intensively.

The embodiment of the carrier according to claim 6 is comparatively simple to be realized, whereas the carrier according to claim 7 has the advantage that the thermal isolation of the outer ring is further increased due to the fact that two thermally isolating layers are created which are separated from each other by means of the inner ring. The inner and the outer layer can be provided according to claim 3 and/or claim 4.

The temperature of the carrier can be a further decreased by additionally or alternatively providing the carrier with at least one cooling rib or web or flag according to claim 8, and/or by at least one leg according to claim 9 so that the abutting surface between the carrier and the lamp (especially its socket) is minimized and the heat transition or conduction from the lamp to the carrier is accordingly decreased, and/or by slits which are provided into the ring of the carrier at both sides of the legs according to claim 10, by which the heat transition or conduction from the legs to the ring, onto which the after-glowing material is applied, is minimized.

All these features as disclosed in the above claims can of course be combined in any combination with each other in order to achieve a desired cooling or temperature decrease of the carrier according to the needs for a certain application and without departing from the scope of the invention as defined by the claims.

Further details, features and advantages of the invention become apparent from the following description of exemplary and preferred embodiments of the invention in connection with the drawings.

### BRIEF DESCRIPTION OF THE DRAWINGS

FIG. 1 shows a first embodiment in different views;

FIG. 2 shows a second embodiment in different views;

FIG. 3 shows a third embodiment in different views; and

FIG. 4 shows a fourth embodiment in different views;

### DETAILED DESCRIPTION OF PREFERRED EMBODIMENTS:

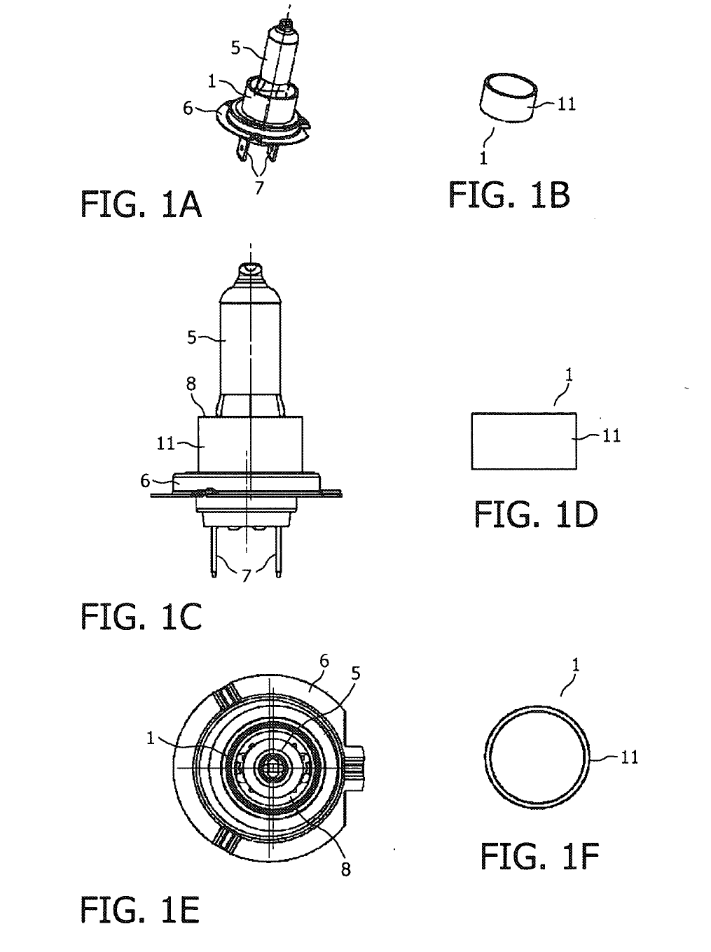

FIG. 1(A) shows in a three-dimensional view a light source in the form of a common halogen socket lamp which is adapted for example for use in a vehicle head lamp unit. The lamp comprises a lamp bulb 5 and a socket 6 for inserting the lamp into a corresponding holder or reflector unit, wherein the socket 6 usually comprises two or three contacts 7 for electrically contacting the lamp with a power supply.

Alternatively, a discharge lamp and/or a light emitting diode (LED) or another light source as mentioned above could be used as well, also in combination with at least one halogen lamp.

Furthermore, FIG. 1(A) shows a first embodiment of a carrier 1 in the form of a cylindrical ring 11 surrounding the lamp bulb 5 in the area of the socket 6 on which it abuts. The carrier 1 is provided with an after-glowing material (for example a luminescent pigment) which is applied at least onto the outer surface of the carrier 1.

FIG. 1(B) shows the carrier 1 in a separate view. Its diameter is dimensioned such that the carrier 1 can be guided over the lamp bulb 5 and that a certain distance or spacing or gap in the form of a thermal isolation layer 8 remains between the lamp bulb 5 and the carrier 1, such that a heating of the carrier 1 due to e.g. heat radiation from the lamp is decreased to a desired amount and thus a thermal isolation is achieved so that the carrier 1 has a lower temperature than the lamp bulb 5.

The length in an axial direction of the cylindrical form of the carrier 1 is preferably dimensioned such that it does not substantially shadow the way of light radiated out of the lamp bulb 5 or, if the lamp is to be inserted into a reflector, between the lamp bulb 5 and the reflector.

Furthermore, by providing the carrier 1 such that it is in mechanical contact with the lamp only via its ring shaped abutment surface (cross sectional surface) at the socket 6 of the lamp, there is only a minimum heat conduction from the lamp socket 6 to the carrier 1.

By at least one of the above two measures (diameter dimensioning and small abutment surface), the temperature of the carrier 1 is considerably lower than the temperature of the lamp bulb 5, so that the duration of the after-glowing effect of the after-glowing material applied onto the carrier 1 can be prolonged considerably in comparison to the case in which the after-glowing material is applied onto the lamp bulb 5.

FIGS. 1(C) and (D) show a side view of the lamp and the carrier 1 according to FIG. 1(A) and (B), respectively. In these Figures it can be recognized that the carrier 1 abuts on the socket 6 of the lamp and longitudinally extends in the direction of the axial length of the lamp to such an extent that the way of the light generated by the lamp is not or only to a minimum shadowed.

FIGS. 1(E) and (F) show a view from above of FIGS. 1(A) to (D) of the lamp and the carrier 1, respectively. FIGS. 1(E) and (F) show that the diameter of the ring 11 of the carrier 1 is selected such that a spacing or gap 8 remains between the cylindrical ring 11 and the substantially cylindrical lamp bulb 5 which are arranged coaxially or concentrically to each other, in order to achieve the above explained thermal isolation layer between both.

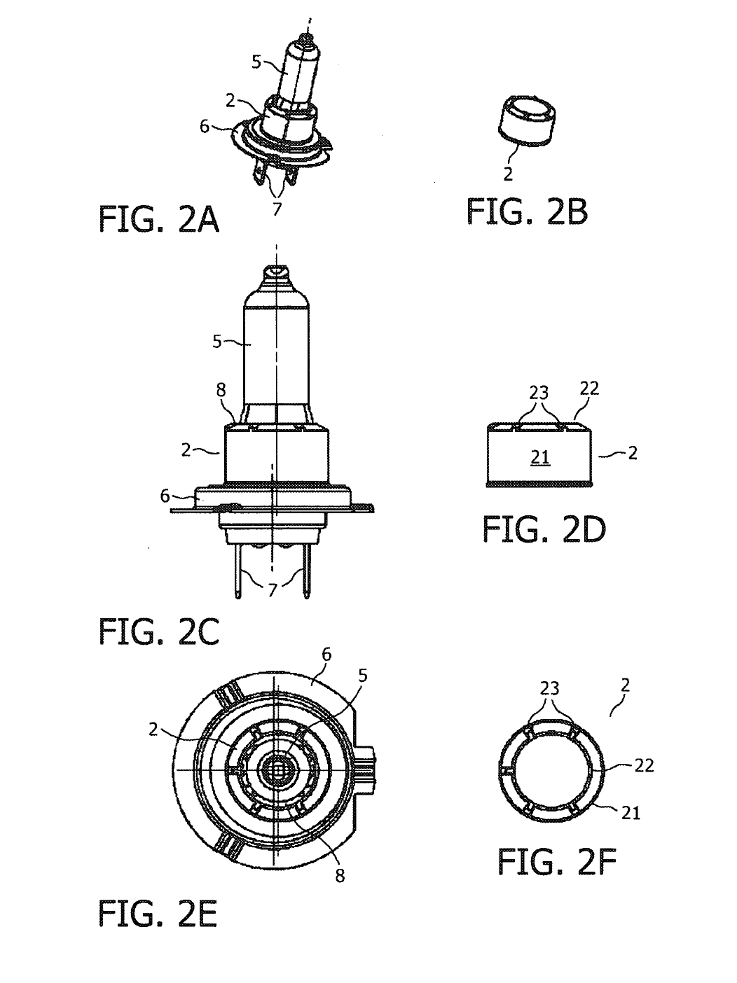

FIGS. 2(A), (C) and (E) again show a common halogen socket lamp as indicated in FIG. 1(A), (C) and (E), respectively, wherein the same or corresponding parts as in FIGS. 1(A), (C) and (E) are denoted with the same reference numerals. This lamp is provided with a second embodiment of a carrier 2 for an after-glowing material, which is shown in separate views in FIGS. 2(B), (D) and (F), respectively.

As especially can be seen in the side view of FIG. 2(C) and in the top view of FIG. 2(E), this carrier 2 is dimensioned with respect to its inner diameter such that it can be guided over the lamp bulb 5 until it abuts at the socket 6 of the lamp as in the above first embodiment, wherein a distance or spacing in the form of a thermal isolation layer 8 remains between the lamp bulb 5 and the carrier 2 when they are arranged coaxially or concentrically to each other.

Furthermore, the carrier 2 is again dimensioned with respect to its axial length preferably such that it does not substantially shadow the way of light radiated out of the lamp bulb 5 or, if the lamp is to be inserted into a reflector, between the lamp bulb 5 and the reflector.

As can be seen especially in FIGS. 2(D) and 2(F), the carrier 2 according to the second embodiment comprises a first cylindrical outer ring 21 and a second cylindrical inner ring 22 which are coaxially or concentrically positioned relative to each other.

For fixing both cylindrical rings 21, 22 to one another, at least one connector 23, for example in the form of a rib, web or frame is provided which extent in the longitudinal direction of the (axial) length of the carrier 2 as indicated in FIGS. 2(B), (D), (F). However, other configurations of connectors for fixing both cylindrical rings 21, 22 to one another can be used as well like for example another at least one ring which extends in a circumferential direction of the carrier.

This second embodiment has the advantage, that by the two coaxial cylindrical rings 21, 22 and the spacing there between, a second thermal isolation layer and an even better thermal isolation of the first cylindrical outer ring 21 against e.g. the heat radiation emitted by the lamp can be achieved so that at the outer ring 21 a lower temperature can be achieved than at the (only one) ring 11 of carrier 1 as indicated in FIG. 1.

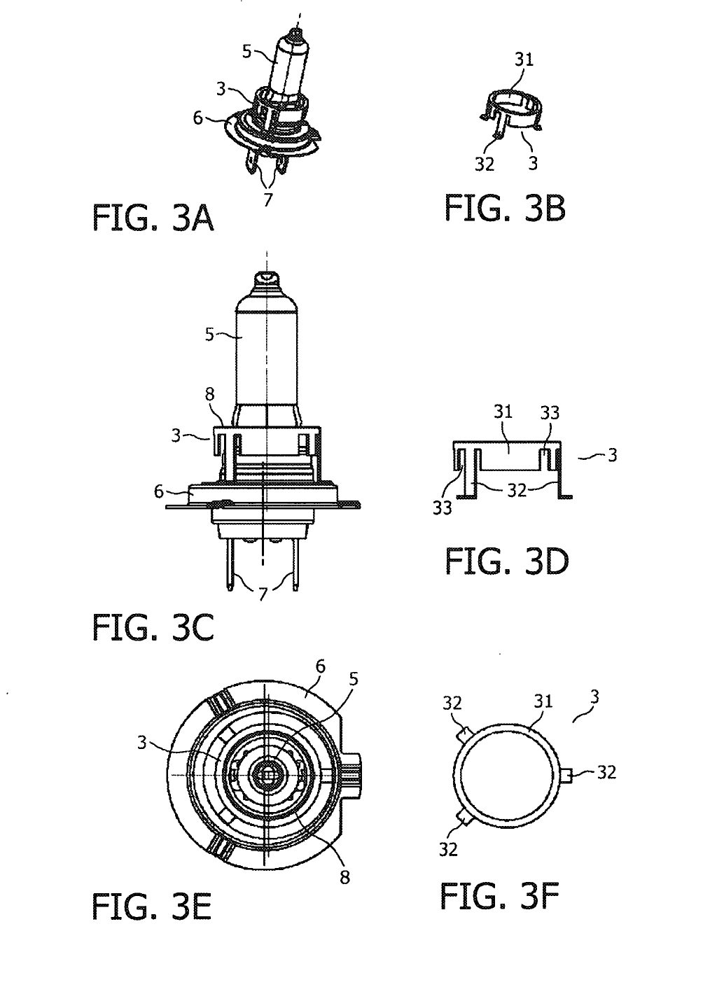

FIGS. 3(A), (C) and (E) again show a common halogen socket lamp as indicated in FIG. 1(A), (C) and (E), respectively, wherein the same or corresponding parts are again denoted with the same reference numerals. This lamp is provided with a third embodiment of a carrier 3 for an after-glowing material, which is shown in separate views in FIGS. 3(B), (D) and (F).

As especially can be seen in the side view of FIG. 3(C) and in the top view of FIG. 3(E), this carrier 3 again comprises a cylindrical ring 31 which is dimensioned with respect to its inner diameter such that it can be guided over the lamp bulb 5 so that a distance or spacing in the form of a thermal isolation layer 8 remains between the lamp bulb 5 and the carrier 3 when they are arranged coaxially or concentrically to each other.

Furthermore, this carrier 3 is provided with at least one but preferably three supporting pillars or legs 32 which are connected with the cylindrical ring 31 and with which the carrier 3 rests at the socket 6 of the lamp. (The first and second embodiment can be provided with such leg(s) as well).

The third embodiment of the carrier 3 has the advantage that the thermal or heat conduction from the socket 6 of the lamp to the cylindrical ring 31 of the carrier 3, onto which the after glowing material is applied, is further reduced due to the smaller contacting surfaces (transition area) between both in comparison to the first and second embodiment.

In order to further enhance this effect, the transition area between the legs 32 and the cylindrical ring 31 can be decreased e.g. by slits 33 which are placed in a longitudinal or axial direction of the cylindrical ring 31 into the ring 31 preferably on both sides of the legs 32 as especially shown in FIG. 3(D).

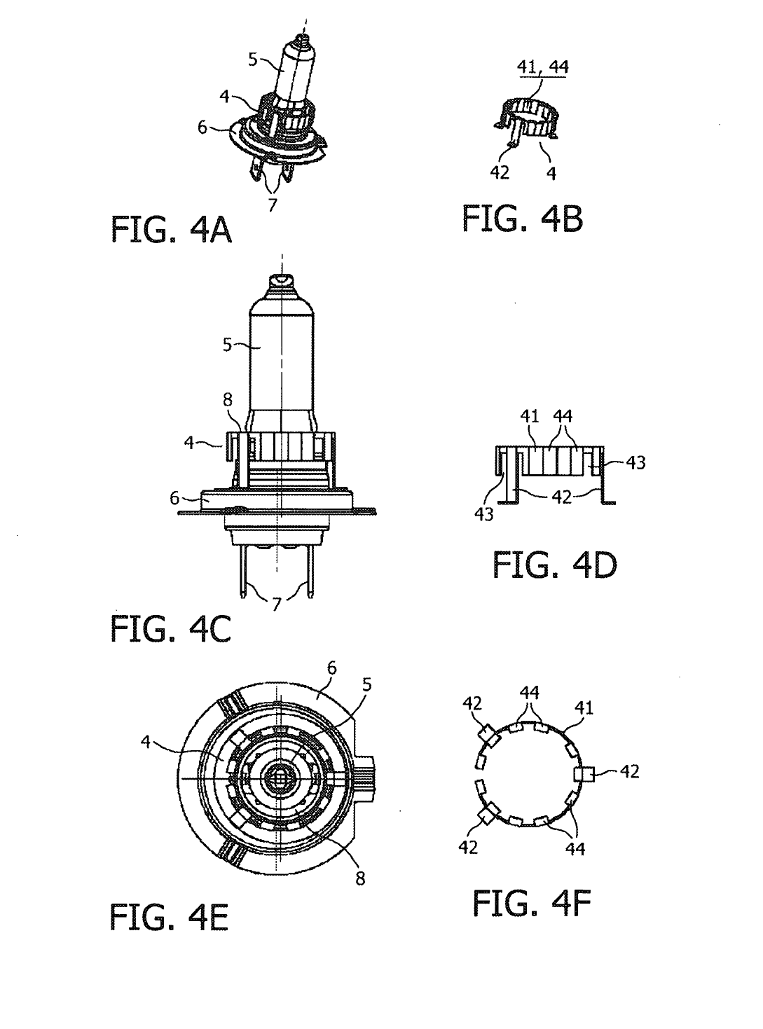

Finally, FIGS. 4(A), (C) and (E) again show a common halogen socket lamp as indicated in FIGS. 1(A), (C) and (E), respectively, wherein the same or corresponding parts are again denoted with the same reference numerals. This lamp is provided with a fourth embodiment of a carrier 4 for an after glowing material, which is shown in separate views in FIGS. 4(B), (D) and (F).

As especially can be seen in the side view of FIG. 4(C) and in the top view of FIG. 4(E), this carrier 4 again comprises a cylindrical ring 41 which is dimensioned with respect to its inner diameter such that it can be guided over the lamp bulb 5 so that a distance or spacing in the form of a thermal isolation layer 8 remains between the lamp bulb 5 and the carrier 4 when they are arranged coaxially or concentrically to each other.

In a similar manner as in the third embodiment of the carrier 3 shown in FIGS. 3, this fourth embodiment of the carrier 4 comprises at least one but preferably three supporting pillars or legs 42 which are connected with the cylindrical ring 41 and with which the carrier 4 rests at the socket 6 of the lamp.

Again, the carriers 3; 4 according to the third and fourth embodiment each are dimensioned with respect to their total axial length (including the legs 32; 42) preferably such that they do not substantially shadow the way of light radiated out of the lamp bulb 5 or, if the lamp is to be inserted into a reflector, between the lamp bulb 5 and the reflector.

In order to further reduce the thermal or heat conduction from the socket 6 of the lamp to the cylindrical ring 41 of the carrier 4 according to the fourth embodiment, again slits 43 are placed in a longitudinal or axial direction into the cylindrical ring 41 preferably on both sides of the legs 42.

Furthermore, as can be seen best in FIGS. 4(D) and (F), the ring 41 is provided with at least one but preferably with a plurality of ribs 44 which extend at the inner surface of the ring 41 in a longitudinal or axial direction of ring 41 and which are distributed over the circumference of the ring 41.

In comparison to the first to third embodiments, the cylindrical ring 41 can be made of a comparatively thinner sheet material. By providing the ribs 44, the surface area of the cylindrical ring 41 is enlarged so that the heat radiation of the cylindrical ring 41 is enhanced and an even lower temperature on its radial outer surface can be achieved.

Additionally, a second (outer or inner) cylindrical ring according to the second embodiment shown in FIG. 2 could be coaxially arranged at this embodiment as well, and/or the carrier 4 according to the fourth embodiment could be provided in the form of one cylindrical ring or two coaxial cylindrical ring(s) without a leg 42 according to the first and second embodiment, respectively (shown in FIGS. 1 and 2), but comprising the ribs 44.

Generally, it is preferred in all embodiments that the carrier is made of metal. However, a synthetic material having similar properties and temperature resistance could be selected as well, wherein a translucent such material can be used as well.

While the invention has been illustrated and described in detail in the drawings and foregoing description, such illustration and description is to be considered illustrative or exemplary and not restrictive, and the invention is not limited to the disclosed embodiments. Modifications to the embodiments of the invention (especially other kinds of lamps and carriers) and any combinations of features (especially of the carriers) described in the foregoing are possible without departing from the scope of the invention as defined by the accompanying claims.

For example, the lamp bulb 5 can have another form than a cylindrical form (or a circular cross section), like e.g. an oval or another cross section, wherein either the ring(s) of the carrier then preferably has (have) a corresponding oval cross section, or a rectangular cross section or a polygonal cross section, especially in order to adapt the form or shape of the carrier (or the ring) in an easy way to the form or shape of the lamp bulb or a related light source so that the at least one thermal isolation layer 8 is provided.

Furthermore, the carrier can be provided in all embodiments with additional cooling elements like ribs or flags that extend at the outside of the carrier in a radial direction.

Generally, the dimensions of the carrier have as well to be selected by a person skilled in the art in dependence on the operating conditions and application of the illuminating device, a certain lamp type, the available space within a reflector unit, a possibly demanded minimum distance of the carrier from a lamp bulb, a radiation characteristic which is not to be impaired etc.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present.

Numerals included within parentheses in the accompanying claims are intended to assist understanding of the claims and should not be construed in any way to limit the subject matter claimed by these claims.

1. Illuminating device comprising a light source (5, 6, 7) for generating light and an after-glowing material for emitting light after the light source (5, 6, 7) is switched off or has extinguished, wherein a carrier (1; 2; 3; 4) is provided onto which the after-glowing material is applied and which carrier (1; 2; 3; 4) is formed to surround at least a part of the light source (5, 6, 7) in a longitudinal and/or circumferential direction of the light source (5, 6, 7), and wherein at least one thermal isolation layer (8) is provided between the light source (5, 6, 7) and the carrier (1; 2; 3; 4) in order to decrease a heating of the carrier by the light source (5, 6, 7).

2. Illuminating device according to claim 1,
wherein the light source (5, 6, 7) comprises a lamp bulb (5) which is at least partly coaxially or concentrically surrounded by the carrier (1; 2; 3; 4), and a socket (6) at which the carrier (1; 2; 3; 4) rests or abuts.

3. Illuminating device according to claim 1,
wherein at least one thermal isolation layer (8) comprises or is formed by a predefined gap or a predefined distance between the light source (5, 6, 7) and the carrier (1; 2; 3; 4) with air in between both.

4. Illuminating device according to claim 1,
wherein at least one thermal isolation layer (8) comprises or is formed by a thermally isolating material.

5. Illuminating device according to claim 1,
wherein the material of the carrier (1; 2; 3; 4) onto which the after-glowing material is applied is made of a metal or a translucent material.

6. Illuminating device according to claim 1,
wherein the carrier (1; 2; 3; 4) comprises at least one ring (11; 21, 22; 31; 41) with a diameter which is dimensioned for coaxially or concentrically surrounding the light source (5, 6).

7. Illuminating device according to claim 1,
wherein the carrier (1; 2; 3; 4) comprises two cylindrical rings (21, 22) which are arranged coaxially or concentrically to each other and which are fixed to each other by means of at least one connector (23) which is positioned between the rings (21, 22).

8. Illuminating device according to claim 6 or 7,
wherein at least one ring (41) of the carrier (1; 2; 3; 4) is provided with at least one cooling rib (44).

9. Illuminating device according to at least one of claims 6 to 8,
wherein the at least one ring (31; 41) is provided with at least one leg (32; 42) for supporting the ring at a socket (6) of the light source (5, 6, 7).

10. Illuminating device according to claim 9,
wherein two slits (33; 43) are provided into the ring (31; 41) extending at both sides of and parallel to the at least one leg (32; 42).
